(19) United States
(12) Patent Application Publication
(10) Pub. No.: US 2012/0283059 A1
(43) Pub. Date: Nov. 8, 2012

(54) ELEMENTS OF VEHICULAR CONTINUOUSLY VARIABLE TRANSMISSION BELT, AND METHOD OF MANUFACTURING THE ELEMENTS

(76) Inventor: Satoru Ando, Nagoya-shi (JP)

(21) Appl. No.: 13/519,080

(22) PCT Filed: Dec. 26, 2009
(86) PCT No.: PCT/JP2009/071705

§ 371 Date: Jun. 25, 2012

(30) Foreign Application Priority Data
Dec. 28, 2009 (JP) 2009-297692

(51) Int. Cl. F16G 1/22; B21D 28/00

(52) U.S. Cl. 474/248; 72/338

(57) ABSTRACT

It is provided an element for a continuously variable transmission belt, in the form of metallic plate supported by annular rings and arranged in a direction of thickness thereof along an annulus of each of the annular rings, wherein said element has a trapezoidal body portion, and a triangular head portion connected to an outer end of said body portion as seen in a radial direction of the continuously variable transmission belt, said body portion and said head portion cooperating to define therebetween ring accommodating slots for accommodating said annular rings; and wherein the head portion of said element has a thickness which decreases as the head portion extends in a direction away from said ring accommodating slots, and has a protruding section formed on one of opposite pressure surfaces thereof, and a recessed section which is formed in the other of said opposite surfaces such that the recessed section is engageable with another of said elements which is adjacent to said each element.

### CROSS-REFERENCE TO RELATED APPLICATIONS

This application is a national phase application of International Application No. PCT/JP2009/071705, filed Dec. 26, 2009, the content of which is incorporated herein by reference.

### TECHNICAL FIELD

The present invention relates to a series of elements of a belt of a continuously variable transmission provided on a vehicle, and a method of manufacturing the series of elements, and more particularly to techniques for improving durability of the elements and reducing a cost of manufacture of the elements.

### BACKGROUND ART

There is known a belt of a belt-type continuously variable transmission, which is provided with annular rings each constituted by a plurality of annular endless band members laminated on each other, and a plurality of elements in the form of metallic plates supported by the annular rings and arranged in a direction of thickness thereof along an annulus of each of the annular rings, and which connects a pair of pulleys groove widths of which are variable. Patent Document 1 describes an example of such a continuously variable transmission belt. This Patent Document 1 discloses a technique for adjusting a gravity center of each of the elements such that a velocity (Vg) of the gravity center of the elements is held within a velocity range between a locking-edge velocity (Vr) of the elements and a velocity Vs of a radially outermost end of ring slots, in a radial direction of the annular rings, accommodating the rings, so as to prevent an inclination of the elements in linear portions (chord portions) of the belt extending between the pair of pulleys, so that the elements smoothly come into engagement with the pulleys.

### PRIOR ART DOCUMENT

### Patent Document

Patent Document 1: JP-11-351335 A

### SUMMARY OF THE INVENTION

### Object Achieved by the Invention

Patent Document 1 describes a technique for reducing a geometric profile of an upper head portion of each of the elements, as one example of the techniques for lowering the gravity center of the element. FIG. 16 is a front elevational view of an element 200, showing an example of reduction of the profile of the head portion of the element 200 (locating the gravity center at an inner position as seen in the radial direction of the belt). The element 200 is a thick plate member formed by punching from a steel plate. The element 200 has a trapezoidal body portion 202, and a triangular head portion 204 connected to a widthwise central part of an upper end or an outer end of the body portion 202 as seen in the radial direction of the belt. The head portion 204 has a pair of ear sections 206 extending symmetrically from a widthwise centerline of the element 200 in a width direction of the element 200. The above-indicated ear sections 206 cooperate with the body portion 202 and the head portion 204 to define therebetween a pair of ring accommodating slots 208 for accommodating annular rings 210.

For lowering the gravity center of the element 200 (namely, for shifting the gravity center in the direction toward the body portion 202), a geometric profile of an outer part of the head portion 204 of the element 200 as seen in the radial direction of the belt is reduced as indicated by hatching lines. However, the reduction of the geometric profile of the head portion 204 results in reduction of a width of the ear sections 206, and consequent reduction of strength of the ear sections 206, giving rise to a possibility of fracture of the ear sections 206 at their proximal parts as indicated by cut-out lines in FIG. 16, by way of example, due to the reduced strength of the ear sections 206, when the ear sections 206 are subject to an upward force exerted from the annular rings 210 in the direction toward the head portion 204 as shown by arrows in FIG. 16 during the continuously variable transmission belt is driven. Accordingly, to avoid a damage of the element 200 it is necessary to limit a maximum operating torque of the continuously variable transmission belt.

The present invention was made in view of the background art described above. It is therefore an object of the present invention to provide a series of elements each constructed so as to permit an adjustment of its gravity center while preventing reduction of the strength of its ear sections, and a method of manufacturing the series of elements.

### Means for Achieving the Object

The object indicated above is achieved according to the present invention, which provides (a) an element for a continuously variable transmission belt, in the form of metallic plate supported by annular rings and arranged in a direction of thickness thereof along an annulus of each of the annular rings, (b) characterized in that the above-described element has a substantially trapezoidal body portion, and a substantially triangular head portion connected to an upper end of the above-described body portion, the above-described body portion and the above-described head portion cooperating to define therebetween ring accommodating slots for accommodating the above-described annular rings, and (c) the head portion of the element has a thickness which decreases as the head portion extends in a direction away from the above-described ring accommodating slots, and has a protruding section formed on one of opposite pressure surfaces thereof, and a recessed section which is formed in the other of the above-described opposite surfaces such that the recessed section is engageable with another of the above-described elements which is adjacent to the above-described each element.

### Advantages of the Invention

According to the present invention, the element is formed such that its thickness decreases as the head portion extends in the direction away from the ring accommodating slots, so that the gravity center of the element is shifted toward the body portion as the mass of the head portion decreases. Since the gravity center of the element is shifted toward the body portion, a moment of rotation of the element during the power transmitting operation of the belt decreases to reduce the tendency of inclination of the element, for thereby preventing reduction of durability of the annular rings due to contact of the annular rings with the element caused by the inclination of the element. Further, the gravity center of the element 4 is shifted toward the body portion by reducing the volume in the direction of thickness of the element, without changing the geometric profile of the element, so that the head portion (ear sections) has a sufficiently high strength. The element having the sufficiently high strength can withstand a relatively high load acting thereon due to a large force exerted from the annular rings to the head portion (ear sections) in the radially outward direction when a relatively large torque acts on the continuously variable transmission belt. That is, the maximum permissible operating torque of the continuously variable transmission belt increases with an increase of the strength of the element (ear sections).

According to a preferred form of the present invention, the above-described head portion of the above-described element has a maximum thickness not smaller than a maximum thickness of the above-described body portion, so that a linear portion (chord portion) of the continuously variable transmission belt between a driving pulley and a driven pulley on the power transmitting side is protected against a waving motion, and the element is permitted to smoothly come into engagement with the driven pulley at its incoming point.

According to another preferred form of the invention, the above-described head portion of the above-described element has at least one slant surface, which reduces the mass of the head portion, so that the gravity center of the element can shifted toward the body portion.

According to a further preferred form of the invention, the head portion of the above-described element has at least one stepped surface, which reduces the mass of the head portion, so that the gravity center of the element can be shifted toward the body portion.

The object indicated above can also be achieved according to the present invention, which provides a method of manufacturing (a) an element for a continuously variable transmission belt, in the form of metallic plate supported by annular rings and arranged plurally in a direction of thickness thereof along an annulus of each of the annular rings, characterized in that (b) the above-described element has a substantially trapezoidal body portion, and a triangular head portion connected to an upper end of the above-described body portion, the above-described body portion and the above-described head portion cooperating to define therebetween ring accommodating slots for accommodating the above-described annular rings, (c) the head portion of the above-described element has a thickness which decreases as the head portion extends in a direction away from the above-described ring accommodating slots, (d) the above-described element is formed from a plate blank having a thickness smaller than maximum thicknesses of the above-described body portion and said head portion, and (e) the above-described element is manufactured with a fine blanking press operated to perform in a single stroke a squeezing process and punching process, such that a portion of the formed element which has a thickness larger than the thickness of the above-described plate blank is formed, in the squeezing process, of an excess material flown from a portion of the above-described plate blank which corresponds to a portion of the formed element which has a thickness smaller than the thickness of the above-described plate blank.

In the method of manufacturing the series of elements according to the present invention, the plate blank which is inexpensive is used to manufacture the element, and the element is formed at a reduced cost with the fine blanking press operated in a single stroke.

### BRIEF DESCRIPTION OF THE DRAWINGS

FIG. 1 is a perspective view showing a continuously variable transmission belt according to one embodiment of this invention, as installed;

FIG. 2 is an enlarged fragmentary perspective view of the continuously variable transmission belt of FIG. 1, with some parts removed therefrom;

FIG. 3 is a front elevational view showing one of elements shown in FIG. 2;

FIG. 4 is a side elevational view of the element of FIG. 2;

FIG. 5 is an enlarged view showing the elements in a portion indicated by an arrow X in FIG. 1;

FIG. 6 is an enlarged view showing the elements in a portion indicated by an arrow Y in FIG. 1;

FIG. 7 is a view schematically illustrating a state of mutual contact of the adjacent elements at specific positions of the belt during its power transmitting operation;

FIG. 8 is a view showing a posture of a conventional element as a comparable example;

FIG. 9 is a view for explaining a squeezing process performed in a fine blanking press;

FIG. 10 is a view for explaining a punching process performed in the fine blanking press, to form the element;

FIG. 11 is a view showing a modification of the element;

FIG. 12 is a view showing another modification of the element;

FIG. 13 is a view for explaining a further modification of the element;

FIG. 14 is a view for explaining another modification of the element;

FIG. 15 is a view for explaining a further modification of the element; and

FIG. 16 is a view showing an example of a head portion of an element a geometric profile of which is reduced to lower the gravity center of the element.

### MODE FOR CARRYING OUT THE INVENTION

Embodiments of the present invention will be described in detail by reference to the drawings. It is to be understood that the drawings showing the embodiments are simplified or transformed as needed, and do not necessarily accurately indicate the dimensions and shapes of individual elements of the embodiments.

### Embodiment 1

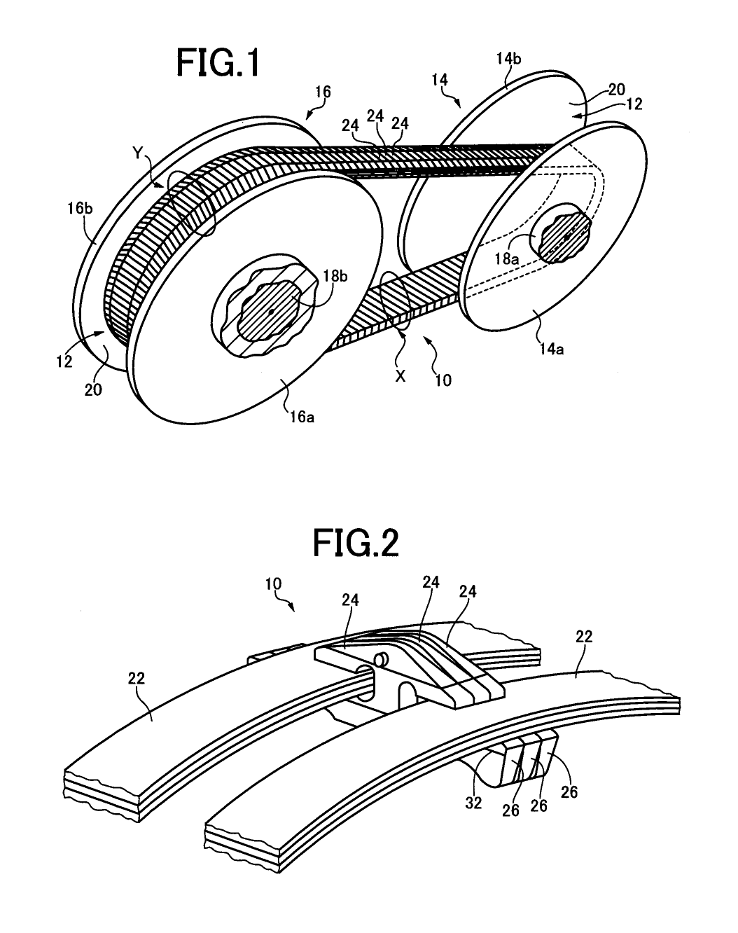

FIG. 1 is the perspective view showing a continuously variable transmission belt 10 according to one embodiment of this invention, as installed. FIG. 2 is the enlarged fragmentary perspective view of the continuously variable transmission belt 10 shown in FIG. 1, with some parts removed therefrom. As shown in FIG. 1, this continuously variable transmission belt 10 is a power transmitting belt (metallic belt) connecting a driving pulley 14 and a driven pulley 16 which have variable-width V-shaped grooves 12 formed in their radially outer portions and which are rotatable about their axes parallel to each other. The driving pulley 14 has a stationary pulley member 14a fixed to a first rotary shaft 18a, and a movable pulley member 14b which is not rotatable relative to the first rotary shaft 18a and which is axially movable relative to the first rotary shaft 18a. The driven pulley 16 has a stationary pulley member 16a fixed to a second rotary shaft 18b, and a movable pulley member 16b which is not rotatable relative to the second rotary shaft 18b and which is axially movable relative to the second rotary shaft 18b. The stationary and movable pulley members 14a, 14b have respective opposite surfaces in the form of a pair of sheave surfaces 20 having an axial distance therebetween, which increases in the radially outward direction, while the stationary and movable pulley members 16a, 16b have respective opposite surfaces in the form of another pair of sheave surfaces 20 having the above-indicated axial distance. The above-described grooves 12 are defined by these pairs of sheave surfaces 20.

The above-described continuously variable transmission belt 10 has a pair of annular rings 22, and a plurality of elements (pieces) 24 in the form of a plurality of metallic plates supported by the pair of annular rings 22 and arranged in their direction of thickness along an annulus of each of the annular rings 22. Each of the annular rings 22 is constituted by a plurality of flexible annular band members of a hoop steel laminated on each other.

The annular band members of each annular ring 22 are formed from a highly tensile steel plate having a thickness of about 0.2 mm and laminated on each other in a radially outward direction of the annular ring 22. In the present embodiment, each annular ring 22 is constituted by nine annular band members laminated on each other.

Each of the elements 24 is a thick plate formed by punching from a plate member (steel plate member) having a thickness of about 1.8 mm. In the present embodiment, the continuously variable transmission belt 10 has about 400 elements 24.

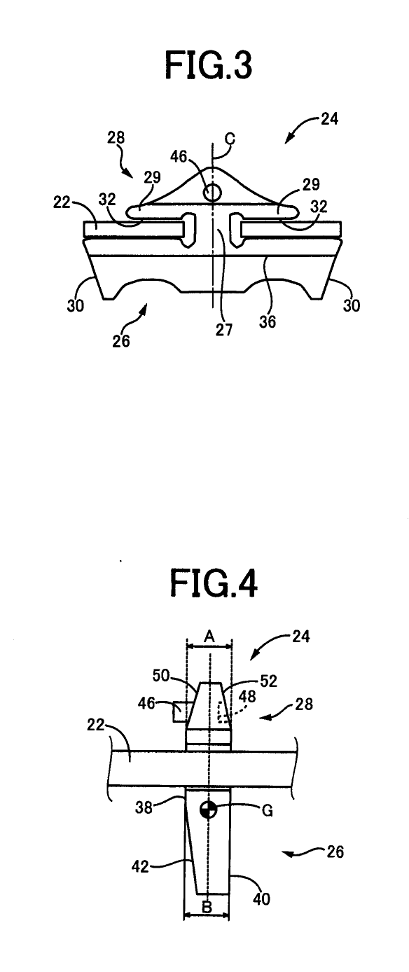

FIG. 3 is the front elevational view of the element 24 shown in FIG. 2, and FIG. 4 is the side elevational view of the element 24. As shown in FIG. 3, the element 24 is formed symmetrically with respect to a centerline C, and has a trapezoidal body portion 26, and a triangular head portion 28 connected to an outer (upper) end (as seen in the radial direction of the belt 10) of the body portion 26 through a connecting portion 27. An outer (upper) surface of the body portion 26 and an inner (lower) surface of the head portion 28 (as seen in the radial direction of the belt 10) define therebetween a pair of ring accommodating slots 32 for accommodating the annular rings 22.

The body portion 26 has a pair of contacting surfaces 30 formed at its opposite right and left end sections, for opposition to and contact with the pair of sheave surfaces 20 shown in FIG. 1, and a locking edge 36 extending in the right and left direction (namely, in a direction perpendicular to the centerline C). Further, the head portion 28 has ear sections 29 formed at its opposite right and left ends so as to extend in the right and left direction.

As shown in the side elevational view of FIG. 4, each of the elements 24 has a first pressure surface 38, a second pressure surface 40 and a third pressure surface 42, so that these pressure surfaces 38, 40, 42 of the adjacent elements 24 contact each other to transmit a force between the adjacent elements 24 during a power transmitting operation of the belt. The first and second pressure surfaces 38, 40 are substantially perpendicular to a direction of movement of the element 24 and are parallel to each other, while the third pressure surface 42 is contiguous to the first pressure surface 38 at the locking edge 36, and is inclined by a predetermined angle with respect to the first pressure surface 38. The head portion 28 has a protruding section 46 formed on the side of the first pressure surface 38, and a recessed section 48 formed on the side of the second pressure surface 40 such that the recessed section 48 is engageable with the protruding section 46 of the adjacent element 24.

The head portion 28 of the element 24 has a thickness which decreases as the head portion 28 extends in the direction away from the ring accommodating slots 32. Described more specifically, the head portion 28 has a slant surface 50 of a predetermined inclination angle formed on the side of the first pressure surface 38, and another slant surface 52 of the predetermined inclination angle formed on the side of the second pressure surface 40. The inclination angle of the above-indicated slant surfaces 50, 52 is determined so that a gravity center G of the element 24 is located near the locking edge 36 in the direction of height of the element 24. Namely, the gravity center G is shifted toward the body portion 26 as a mass of the head portion 28 decreases with a decrease of a cross-sectional surface area of the head portion 28 in a cross-sectional plane parallel to the direction of thickness due to the provision of the slant surfaces 50, 52. For instance, an increase of the inclination angle of the slant surfaces 50, 52 causes a decrease of the mass (volume) of the head portion 28, and a consequent increase of a distance of shifting of the gravity center G toward the body portion 26. Thus, the location of the gravity center G of the element 24 is adjusted by adjusting the mass of the head portion 28 by changing the inclination angle of the slant surfaces 50, 52, so that the gravity center G is located near the locking edge 36. The head portion 28 has a maximum thickness A which is determined to be not smaller than a maximum thickness B of the body portion 26 (thickness at the locking edge 36). For example, a difference of the maximum thicknesses A and B is held within a range of about 0-0.01 mm.

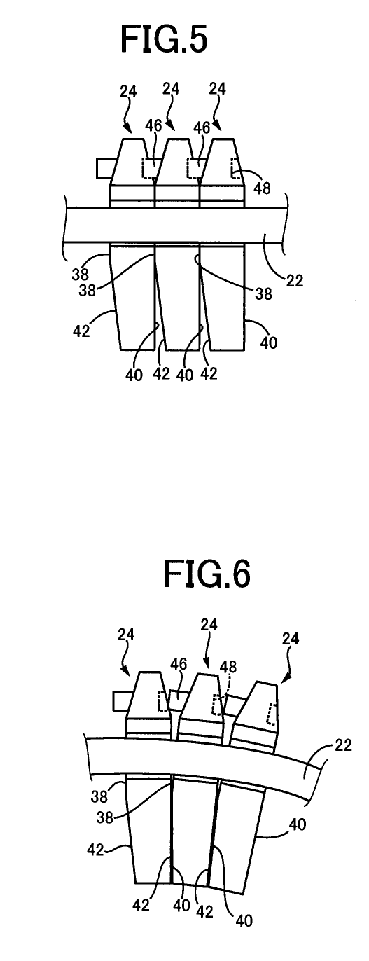

FIG. 5 shows the elements 24 in a portion of the belt 10 indicated by an arrow X in Fig. L In the portion of the belt 10 indicated by the arrow X, the first and second pressure surfaces 38, 40 of the elements 24 are substantially perpendicular to the direction of movement of the elements 24 (direction of extension of the annular rings 22). In this state, the first pressure surface 38 and the second pressure surface 40 of the adjacent elements 24 are held in pressing contact with each other, as shown in FIG. 5, to transmit a force therebetween. FIG. 6 shows the elements 24 in a portion of the belt 10 indicated by an arrow Y in Fig. L In the curved portion of the continuously variable transmission belt 10 indicated by the arrow Y, the elements 24 are pressed on their contacting surfaces 30 by the sheave surfaces 20 of the pulley 14. In this state, the second pressure surface 40 and the third pressure surface 42 of the adjacent elements 24 are held in pressing contact with each other, as shown in FIG. 6.

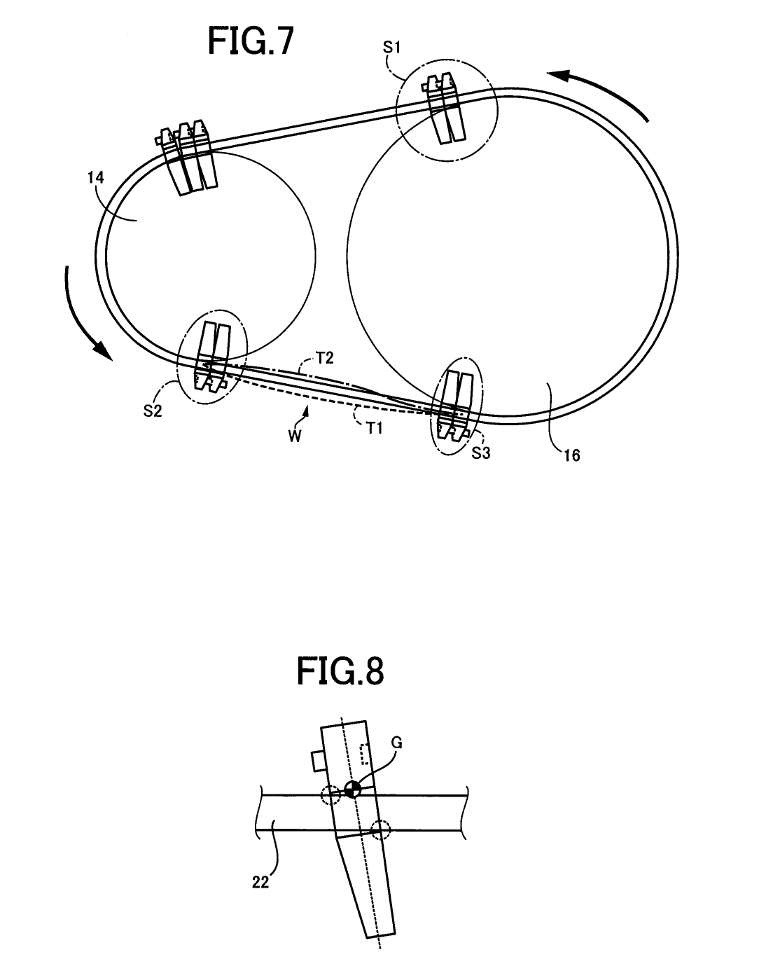

There will be described an operation and advantages of the elements 24 constructed as described above. FIG. 7 is the view schematically illustrating a state of mutual contact of the adjacent elements 24 at specific positions of the belt during its power transmitting operation. The gravity center G of each element 24 is located near the locking edge 36 by forming the head portion 28 of the element 24 such that the thickness of the element 24 decreases as the head portion 28 extends in the direction away from the ring accommodating slots 32. Accordingly, a tendency of pitching inclination of the elements 24 at an outgoing point S 1 of the driven pulley 16 is reduced to reduce local mutual contacts of the surfaces of the ring accommodating slots 32 of the elements 24 and the annular rings 22, as indicated in FIG. 4, so that a load acting on the annular rings 22 is reduced, and the durability of the annular rings 22 is improved. FIG. 8 shows a posture of a conventional element as a comparative example. The element tends to locally contact with the annular rings 22 as indicated by broken-line circles in FIG. 8, due to a relatively large angle of pitching inclination of the element, resulting in reduction of the durability of the annular rings 22.

At an outgoing point S2 of the driving pulley 14 indicated in FIG. 7, the annular rings 22 press the ear sections 29 of the elements 24 toward the head portion 28, whereby proximal portions of the ear sections 29 are subject to a shearing force. While the cross-sectional surface area of the head portion 28 of each element 24 in the cross-sectional plane parallel to the thickness direction is reduced, the geometric profile of the head portion 28 of the element 24 in a plane of the front elevational view is not reduced, so that the strength of the element 24 is substantially sufficiently high, whereby the reduction of durability of the element 24 is reduced.

Further, the head portion 28 of the element 24 has the maximum thickness A determined to be not smaller than the maximum thickness B of the body portion 26, as indicated in FIG. 4 and as described above, so that a linear portion (chord portion) W of the continuously variable transmission belt 10 between the outgoing point S2 of the driving pulley 14 and an incoming point S3 of the driven pulley 16 is held in a substantially linearly extending state or in a slightly outwardly deflected or curved state as indicated by a broken line T1 in FIG. 7. In these states of the linear portion of the continuously variable transmission belt 10, the element 24 is protected against radially inward sticking to the driving pulley 14 at the outgoing point S2, and is at the same time permitted to smoothly come into engagement with the driven pulley 16 at the incoming point S3. If the maximum thickness B of the body portion 26 was larger than the maximum thickness A of the head portion 28, the linear portion W of the continuously variable transmission belt 10 between the driving pulley 14 and the driven pulley 16 would be held in a radially inwardly deflected or curved state, as indicated by a one-dot chain line T2 in FIG. 7, causing a tendency of the radially inward sticking of the element 24 to the driving pulley 14 at the outgoing point S2, and difficulty of the element 24 to smoothly come into engagement with the driven pulley 16 at the incoming point S3 due to the curvature of the continuously variable transmission belt 10.

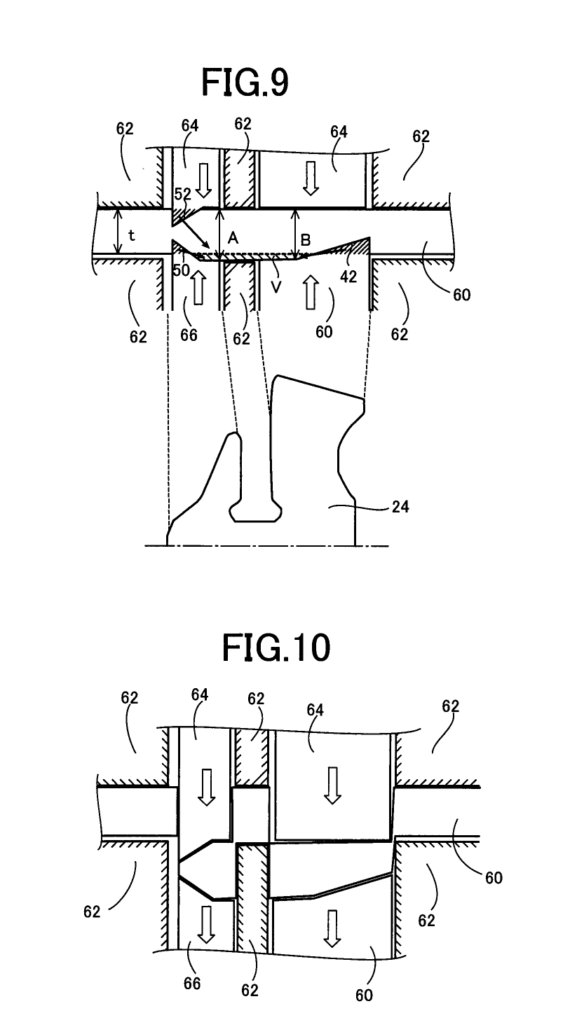

A method of manufacturing the element 24 will be described next. The element 24 is manufactured by a fine blanking press known in the art. The fine blanking press is a pressing machine constructed to perform a fine punching operation in a single stroke at a lower cost than conventional squeezing and punching operations in successive two strokes at respective two stations. FIG. 9 is the view for explaining a squeezing process performed in the fine blanking press, and FIG. 10 is the view for explaining a punching process performed in the fine blanking press, to form the element 24. Although the squeezing process and punching process to be performed in two steps will be described for easier understanding of the method, these two processes are actually performed in the single pressing stroke within a short time in the same fine blanking press.

Initially, the squeezing process will be described by reference to FIG. 9. As a material for the element 24, a flat plate blank 60 (steel plate) is used. The plate blank 60 has a thickness t smaller than the maximum thicknesses A, B of the head and body portions 28, 26 of the element 24. As shown in FIG. 9, the plate blank 60 is set between upper and lower dies 62, and is pressed and plastically deformed by a punch 64 and an ejector 66. At this time, the plate blank 60 is squeezed according to tapered surfaces of the punch 64 and ejector 66, whereby the third pressure surface 42 and the slant surfaces 50, 52 of the element 24 are formed.

When the above-described third pressure surface 42 and slant surfaces 50, 52 are formed, a volume of the material of the plate blank 60 corresponding to a volume of a portion of the punch 64 indicated by hatching lines and a volume of a portion of the ejector 66 indicated by hatching lines flows into a space indicated by a hatched area V between the plate blank 60 and the ejector 66, so that the body portion 26 and head portion 28 having the thicknesses larger than the thickness of the plate blank 60. Namely, a portion of the finally formed element 24 which has a thickness larger than the thickness t of the plate blank 60 is formed of the excess material flown from a portion of the plate blank 60 which corresponds to a portion of the finally formed element 24 having a thickness smaller than the thickness t of the plate blank 60. It is noted that the punch 64 and ejector 66 are preliminary configured so that the maximum thickness A of the head portion 28 is not smaller than the maximum thickness B of the body portion 26.

In the next punching process shown in FIG. 10, punch 64 and ejector 66 are moved downwards to perform the punching process of the element 24. As the element 24 is formed into its predetermined geometric profile, the ring accommodating slots 32 are formed.

The fine blanking press described above may be used to form the elements 24 having different thicknesses, from the same plate blank 60, by appropriately designing the dies 62 punch 64 and ejector 66 to change squeezing amount. By using the elements 24 having the different thicknesses, the circumferential length of the continuously variable transmission belt 10 can be suitably adjusted upon installation of the belt 10.

In the present embodiment described above, the element 24 is formed such that its thickness decreases as the head portion 28 extends in the direction away from the ring accommodating slots 32, so that the gravity center G of the element 24 is shifted toward the body portion 26 as the mass of the head portion 28 decreases. Since the gravity center G of the element 24 is shifted toward the locking edge 36, a moment of rotation of the element 24 during the power transmitting operation of the belt decreases to reduce the tendency of inclination of the element 24, for thereby preventing reduction of durability of the annular rings 22 due to contact of the annular rings 22 with the element 24 caused by the inclination of the element 24. Further, the gravity center G of the element 24 is shifted toward the body portion 26 by reducing the cross-sectional surface area of the head portion 28 in the cross-sectional plane parallel to the direction of thickness of the element 24, without reducing the geometric profile of the head portion 28 of the element 24, so that the head portion has a sufficiently high strength. The element 24 having the sufficiently high strength can withstand a relatively high load acting thereon due to a large force exerted from the annular rings 22 to the head portion 28 (ear sections 29) in the radially outward direction when a relatively large torque acts on the continuously variable transmission belt 10. That is, the maximum permissible operating torque of the continuously variable transmission belt 10 increases with an increase of the strength of the element 24.

The present embodiment is further configured such that the head portion 28 of the element 24 has the slant surfaces 50, 52, which reduce the mass of the head portion 28 to thereby shift the gravity center G of the element 24 toward the body portion 26 (locking edge 36).

The present embodiment is further configured such that the head portion 28 of the element 24 has the maximum thickness A not smaller than the maximum thickness B of the body portion 26, so that the linear portion W of the continuously variable transmission belt 10 between the driving pulley 14 and the driven pulley 16 on the power transmitting side is protected against deflection or curvature (a waving motion), and the element 24 is permitted to smoothly come into engagement with the driven pulley 16 at the incoming point S3.

The present embodiment is further configured such that the plate blank 60 which is inexpensive is used to manufacture the element 24, and the element 24 is formed at a reduced cost with the fine blanking press operated in a single stroke.

Another embodiment of this invention will be described. In the following description, the same reference signs as used in the preceding embodiment will be used to identify the corresponding elements, which will not be described.

### Embodiment 2

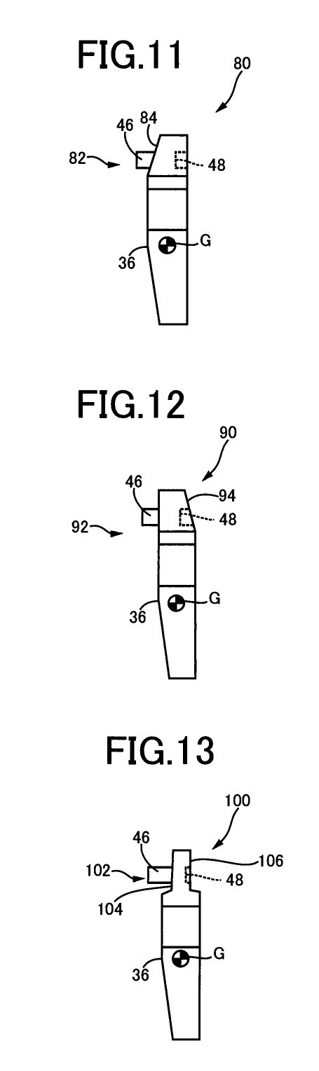

FIGS. 11 through 15 show modifications of the element 24 described above. FIGS. 11-15 are all side elevational views, and the modified elements shown therein have the same geometric profile in the front elevational view, as the element 24. The modified element 80 shown in FIG. 11 has a head portion S2 having only one slant surface 84 on the side of the protruding section 46. In this case, too, the gravity center G can be located near the locking edge 36, by suitably designing the slant surface 84, so that the element 80 has substantially the same function and advantages as the element 24.

The modified element 90 shown in FIG. 12 has a head portion 92 having only one slant surface 94 on the side of the recessed section 48. In the modified element 90 thus constructed, too, the gravity center G can be located near the locking edge 36, by suitably designing the slant surface 94, so that the element 90 has substantially the same function and advantages as the element 24.

The modified element 100 shown in FIG. 13 has a head portion 102 having a stepped surface 104 on the side of the protruding section 46, and a stepped surface 106 on the side of the recessed section 48. In the modified element 100 thus constructed, too, the gravity center G can be located near the locking edge 36, by suitably designing the stepped surfaces 104, 106, so that the element 100 has substantially the same function and advantages as the element 24. It is noted that the formation of the above-indicated stepped surfaces 104, 106 is another mode of an arrangement that permits the head portion 102 to have the thickness which decreases as the head portion 102 extends in the direction away from the ring accommodating slots 32.

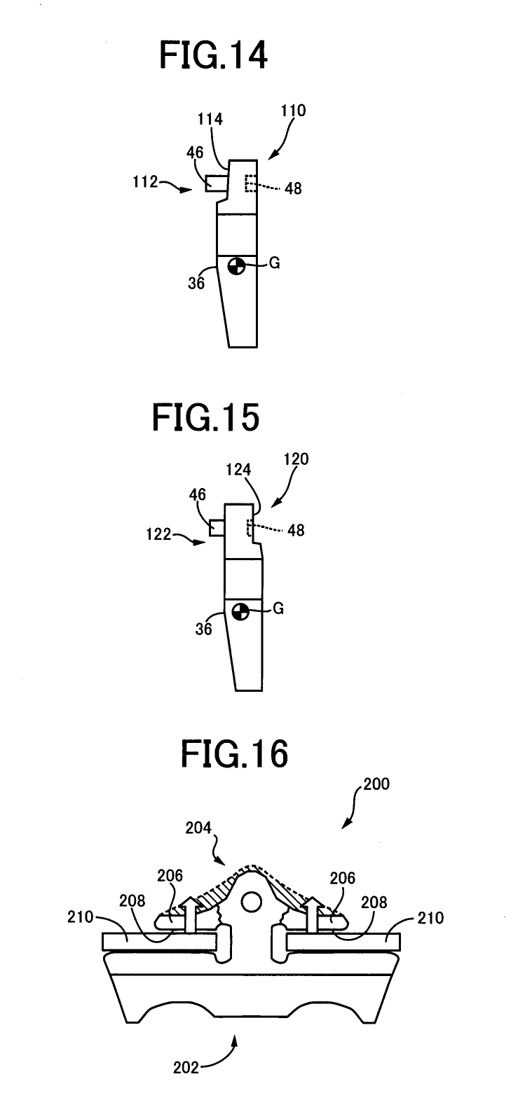

The modified element 110 shown in FIG. 14 has a head portion 112 having only one stepped surface 114 on the side of the protruding section 46. In the modified element 110 thus constructed, too, the gravity center G can be located near the locking edge 36, by suitably designing the stepped surface 114, so that the modified element 110 has substantially the same function and advantages as the element 24.

The modified element 120 shown in FIG. 15 has a head portion 122 having only one stepped surface 124 on the side of the recessed section 48. In the modified element 120 thus constructed, too, the gravity center G can be located near the locking edge 36 by designing the stepped surface 124 appropriately, so that the modified element 120 has substantially the same function and advantages as the element 24.

Further modified elements having a combination of the slant surface and the stepped surface, for example, a slant surface on the side of the protruding section 46 and a stepped surface on the side of the recessed section 48, have substantially the same function and advantages as the modified elements described above. It is noted that the elements (80, 90, 100, 110, 120) shown in FIGS. 11-15 are formed with the fine blanking press described above.

As described above, according to the above-described embodiments, the gravity center G of the elements (80, 90, 100, 110, 120) constructed as described above can be located near the locking edge, so that these elements have substantially the same function and advantages as described above with respect to the preceding embodiment.

In the present embodiment, the head portion of the elements 100, 110, 120 has at least one stepped surface 104, 106, 114, 124, which reduces the mass of the head portion of the elements 100, etc., so that the gravity center G of the elements 100, etc. can be shifted toward the body portion 26.

While the embodiments of this invention have been described in detail by reference to the drawings, it is to be understood that the invention may be otherwise embodied.

In the illustrated embodiments, the gravity center G is located near the locking edge 36 by forming the slant surface or surfaces, and/or the stepped surface or surfaces in the head portion. However, the head portion may be otherwise configured as desired, so as to reduce its thickness and to reduce mass of the head portion without departing from the scope of the present invention.

It is to be understood that the foregoing embodiments and modifications have been described for illustrative purpose only, and that the present invention may be embodied with various other changes and improvements which may occur to those skilled in the art.

### NOMENCLATURE OF REFERENCE SIGNS

10: Continuously variable transmission belt
22: Annular rings
24, 80, 90, 100, 110, 120: Elements
26: Body portion
28, 82, 92, 102, 112, 122: Head portion
32: Ring accommodating slots
50, 52, 84, 94: Slant surface
104, 106, 114, 124: Stepped surface

1. An element for a continuously variable transmission belt, in the form of metallic plate supported by annular rings and arranged in a direction of thickness thereof along an annulus of each of the annular rings,
wherein said element has a trapezoidal body portion, and a triangular head portion connected to an outer end of said body portion as seen in a radial direction of the continuously variable transmission belt, said body portion and said head portion cooperating to define therebetween ring accommodating slots for accommodating said annular rings; and
wherein the head portion of said element has a thickness which decreases as the head portion extends in a direction away from said ring accommodating slots, and has a protruding section formed on one of opposite pressure surfaces thereof, and a recessed section which is formed in the other of said opposite surfaces such that the recessed section is engageable with another of said elements which is adjacent to said each element.

2. The element according to claim 1, wherein said head portion of said element has a maximum thickness not smaller than a maximum thickness of said body portion.

3. The element according to claim 1, wherein the head portion of said element has at least one slant surface.

4. The element according to claim 1, wherein the head portion of said element has at least one stepped surface.

5. A method of manufacturing an element for a continuously variable transmission belt, in the form of metallic plate supported by annular rings and arranged plurally in a direction of thickness thereof along an annulus of each of the annular rings, wherein:
said element has a substantially trapezoidal body portion, and a triangular head portion connected to an upper end of said body portion, said body portion and said head portion cooperating to define therebetween ring accommodating slots for accommodating said annular rings;
the head portion of said element has a thickness which decreases as the head portion extends in a direction away from said ring accommodating slots;
said element is formed from a plate blank having a thickness smaller than maximum thicknesses of said body portion and said head portion; and
said element is manufactured with a fine blanking press operated to perform in a single stroke a squeezing process and punching process, such that a portion of the formed element which has a thickness larger than the thickness of said plate blank is formed, in said squeezing process, of an excess material flown from a portion
of said plate blank which corresponds to a portion of the formed element which has a thickness smaller than the thickness of said plate blank.
